(19) United States
(12) Patent Application Publication
(10) Pub. No.: US 2017/0188163 A1
(43) Pub. Date: Jun. 29, 2017

(54) HEARING ASSISTANCE DEVICE EARHOOK AND SOUND TUBE ANTENNAS

(71) Applicants: Jay Rabel, Shorewood, MN (US); Sidney A. Higgins, Maple Grove, MN (US); Brian Dobson, Maple Grove, MN (US); Casey Edward Murray, Apple Valley, MN (US)

(72) Inventors: Jay Rabel, Shorewood, MN (US); Sidney A. Higgins, Maple Grove, MN (US); Brian Dobson, Maple Grove, MN (US); Casey Edward Murray, Apple Valley, MN (US)

(21) Appl. No.: 14/979,867

(22) Filed: Dec. 28, 2015

(51) Int. Cl. H04R 25/00

(52) U.S. Cl. CPC H04R 25/608; H04R 25/652; H04R 2225/63; H04R 2225/021; H04R 2225/51

(57) ABSTRACT

Wireless communication antennas for hearing assistance devices are provided. In various embodiments, a hearing assistance device includes a housing configured to be worn on or behind the ear, hearing assistance electronics enclosed in the housing, an ear mold configured to be worn in the ear, a sound tube configured to connect to the earmold and to transmit an acoustic output to the earmold, and an earhook configured to connect the housing to the sound tube. At least one of the earmold, the sound tube, and the earhook includes a conductive polymer forming at least a portion of an antenna for wireless communication, in various embodiments.

### RELATED APPLICATIONS

The present application is related to U.S. patent application Ser. No. 12/027,151 filed on Feb. 6, 2008 (now U.S. Pat. No. 8,867,765), which is hereby incorporated herein by reference in its entirety.

### TECHNICAL FIELD

This document relates generally to hearing assistance systems and more particularly to earhook and sound tube antennas for hearing assistance devices.

### BACKGROUND

Hearing assistance devices, such as hearing aids, are used to assist patient's suffering hearing loss by transmitting amplified sounds to ear canals. In one example, a hearing aid is worn in and/or around a patient's ear. Hearing aids should be small and of appropriate form-factor to be unobtrusive and comfortable for the patient to wear. Size limitations of the hearing aid housing can limit the performance of the hearing aid antenna system, since antenna size and form factor affect efficiency. This in turn limits quality and range of the wireless communications link.

There is a need in the art for improved antenna systems for electronic wireless communication for hearing assistance devices.

### SUMMARY

Disclosed herein, among other things, are apparatus and methods for electronic wireless communication antennas for hearing assistance devices. In various embodiments, a hearing assistance device includes a housing configured to be worn on or behind the ear, hearing assistance electronics enclosed in the housing, an earmold configured to be worn in the ear, a sound tube configured to connect to the earmold and to transmit an acoustic output to the earmold, and an earhook configured to connect the housing to the sound tube. At least one of the earmold, the sound tube, and the earhook includes a conductive polymer forming at least a portion of an antenna for wireless communication, in various embodiments.

Various aspects of the present subject matter include a hearing assistance device including a housing configured to be worn on or behind the ear, hearing assistance electronics enclosed in the housing, a wireless communications receiver in the housing and configured to connect to the hearing assistance electronics, an earmold configured to be worn in the ear, a sound tube configured to connect to the earmold and to transmit an acoustic output to the earmold, and an earhook configured to connect the housing to the sound tube. In various embodiments, at least one of the earmold, the sound tube, and the earhook include a conductive polymer configured to provide at least a portion of an antenna for wireless communication. The device includes one or more couplers configured to selectively couple the electrical conductor to the wireless communications receiver to form the antenna, in various embodiments.

This Summary is an overview of some of the teachings of the present application and not intended to be an exclusive or exhaustive treatment of the present subject matter. Further details about the present subject matter are found in the detailed description and appended claims. The scope of the present invention is defined by the appended claims and their legal equivalents.

### BRIEF DESCRIPTION OF THE DRAWINGS

Various embodiments are illustrated by way of example in the figures of the accompanying drawings. Such embodiments are demonstrative and not intended to be exhaustive or exclusive embodiments of the present subject matter.

FIG. 1 illustrates a block diagram of a hearing assistance device with wireless communication, according to various embodiments of the present subject matter.

FIG. 2 illustrates a side view of a behind-the-ear hearing assistance device with wireless communication, according to various embodiments of the present subject matter.

FIG. 3 illustrates a rear view of a behind-the-ear hearing assistance device with wireless communication, according to various embodiments of the present subject matter.

FIGS. 4A-4B illustrate couplers for selectively combining conductors to form a hearing assistance device antenna, according to various embodiments of the present subject matter.

FIG. 5 illustrates a coupler for selectively combining conductors to form a hearing assistance device antenna, according to various embodiments of the present subject matter.

### DETAILED DESCRIPTION

The following detailed description of the present subject matter refers to subject matter in the accompanying drawings which show, by way of illustration, specific aspects and embodiments in which the present subject matter may be practiced. These embodiments are described in sufficient detail to enable those skilled in the art to practice the present subject matter. References to “an”, “one”, or “various” embodiments in this disclosure are not necessarily to the same embodiment, and such references contemplate more than one embodiment. The following detailed description is demonstrative and not to be taken in a limiting sense. The scope of the present subject matter is defined by the appended claims, along with the full scope of legal equivalents to which such claims are entitled.

The present detailed description will discuss hearing assistance devices using the example of hearing aids. Hearing aids are only one type of hearing assistance device. Other hearing assistance devices include, but are not limited to, those in this document. It is understood that their use in the description is intended to demonstrate the present subject matter, but not in a limited or exclusive or exhaustive sense.

Hearing aids should be small and of appropriate form-factor to be unobtrusive and comfortable for the patient to wear. Size limitations of the hearing aid housing can limit the performance of the hearing aid antenna system, since antenna size and form factor affect efficiency. This in turn limits quality and range of the wireless communications link. Previous methods to combat this problem included increasing hearing aid size, reducing the size of other hearing aid components or removing hearing aid components to make room for a larger antenna. However, increasing hearing aid size makes the device more noticeable (less discrete) and less comfortable to wear. In addition, reducing component size or removing components can reduce hearing aid performance and increase cost. The present subject matter solves the problem of limiting the hearing aid antenna size and form factor to the hearing aid. The present subject matter improves antenna system performance, and hence wireless link performance and range, without increasing the size of the hearing aid and without reducing hearing aid functionality.

The present subject matter uses all or part of the earhook, sound tube, ear mold and/or other parts of the hearing aid as an antenna element by including one or more conductors in those parts. In addition, various embodiments of the present subject matter include one or more couplers to selectively include or exclude the conductors to tune and align the resulting antenna. Thus, the present subject matter increases system antenna radiation efficiency and gain (larger aperture), and improves antenna alignment with multiple polarizations for better performance across multiple use-cases, thus improving wireless link performance and range, without increasing the size of the hearing aid or loss of functionality.

The present subject matter can use electrical conductors in one or more of the following features as antenna elements: part or all of the earhook, part or all of the sound tube, and/or part or all of the earmold (or ear bud). Electrical conductors can include wire, traces, other metal parts, conductive materials, and/or metalized polymers (coated or impregnated). In various embodiments, the electrical conductors used as antenna elements include, but are not limited to, wire or formed metal parts, conductors on rigid or flex circuit boards, other metal parts (metal parts other than wire or conductors on circuit boards), and/or conductive polymers. The conductive polymers include, but are not limited to, parts coated with conductive polymers, parts coated with conductive polymer ink(s), and/or parts made of conductive polymers (for example, moldable conductive resins). The conductors can be attached to (inside or outside) or integrated (partially or entirely) into the earhook, sound tube and/or earmold/ear bud. In various embodiments, the conductors can be partially or entirely embedded inside an earhook, a sound tube, an earmold, and/or an ear bud. The conductors can be molded partially or entirely into an earhook, a sound tube, an earmold, an ear bud, in various embodiments.

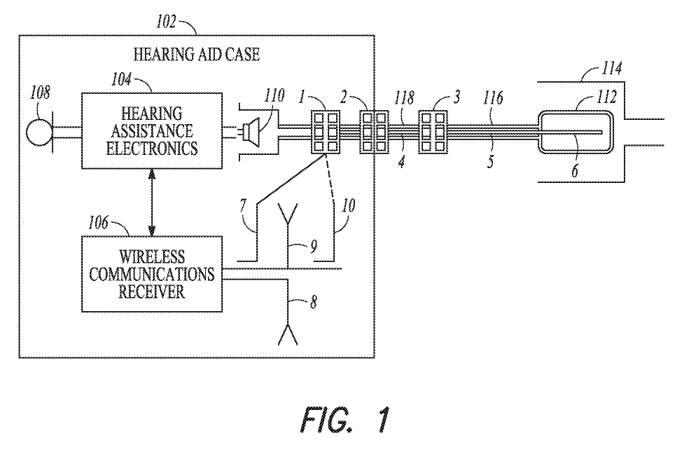

FIG. 1 illustrates a block diagram of a hearing assistance device with wireless communication, according to various embodiments of the present subject matter. In various embodiments, a hearing assistance device includes a housing (or case) 102 configured to be worn on or behind the ear 114, hearing assistance electronics 104 enclosed in the housing, an earmold 112 configured to be worn in the ear, a sound tube 116 configured to connect to the earmold and to transmit an acoustic output to the earmold, and an earhook 118 configured to connect the housing to the sound tube. At least one of the earmold, the sound tube, and the earhook includes one or more electrical conductors 4, 5, 6 forming at least a portion of an antenna for wireless communication, in various embodiments. Various embodiments include a wireless communications transceiver 106, a microphone 108 and a receiver 110 within the housing 102. In various embodiments, the wireless communications transceiver 106 can be replaced with a wireless communications transmitter and/or a wireless communications receiver.

One or more external antenna elements, such as electrical conductors 4, 5, 6, can be combined with one or more internal antenna elements 8, 9 to form various dipole or monopole antenna configurations, in various embodiments. Electrical conductors in one or more of the following heating aid features can be used as internal antenna elements: including, but not limited to, hearing aid spine, outer case, microphone cover, battery door, other structural of functionally desired parts, or combinations thereof, in various embodiments. Electrical conductors can include, but are not limited to, wire, other metal parts, metalized polymers (coated, plated or impregnated). In various embodiments, the internal antenna element electrical conductors include, but are not limited to, wire or formed metal parts, conductors on rigid or flex circuit boards, other metal parts (other than wire or conductors on circuit boards), and/or conductive polymers, including but not limited to, parts coated with conductive polymers, parts coated with conductive polymer ink(s), parts plated with metal, and/or parts made of conductive polymers (example: moldable conductive resins).

In various embodiments, the internal antenna element electrical conductors can be attached to (inside or outside) or integrated partially or entirely into the hearing aid spine, outer case, or other structural parts. In various embodiments, the conductors can be partially or entirely embedded inside a hearing aid spine, a hearing aid case, a hearing aid earhook attachment structure, a hearing aid microphone cover, and/or a hearing aid battery door. The conductors can be molded partially or entirely into a heating aid spine, a hearing aid case, a heating aid earhook attachment structure, a hearing aid sound tube attachment structure, a heating aid microphone cover, and/or a hearing aid battery door, in various embodiments. Other locations for the internal antenna element electrical conductors can be used without departing from the scope of the present subject matter.

One or more electrical conductors (external, internal, or in combination) can be electrically coupled to form desired antenna element electrical lengths such a one quarter wavelength at the desired frequency of operation, in various embodiments. In one example from FIG. 1, elements 1 through 9 are combined to feature an internal dipole with an external antenna element coupled in parallel with one internal dipole arm. This example uses multiple couplers 1, 2, 7 that can be selected as needed for use with different BTE physical designs (case, spine, earhook/sound tube v. thin tube). In various embodiments, the couplers 1, 2, 3, 7 are radio frequency (RF) couplers that can be selectively activated to include, exclude or adjust level of coupling to portions of conductor 4, 5, 6 to increase or decrease effective antennal electrical length. For example, internal couplers or connections can be placed before internal antenna element 7 or after internal antenna element 10.

RF couplers or direct electrical connections may be used to couple RF energy to and from the external antenna elements. Electrical conductors used in the couplers can include wire, other metal parts and metalized polymers (coated, plated or impregnated). The coupler electrical conductors can include, but are not limited to, wire or formed metal parts, conductors on rigid or flex circuit boards, other metal parts (other than wire or conductors on circuit boards), and/or conductive polymers. The conductive polymers can include, but are not limited to, metalized polymers, parts coated with conductive polymers (example: conductive polymer ink), parts plated with metal, and/or parts made of conductive polymers (example: moldable conductive resins). In addition, the electrical conductors can include polymers realized using laser direct structuring (LDS) or other methods of selectively plating polymers with metal.

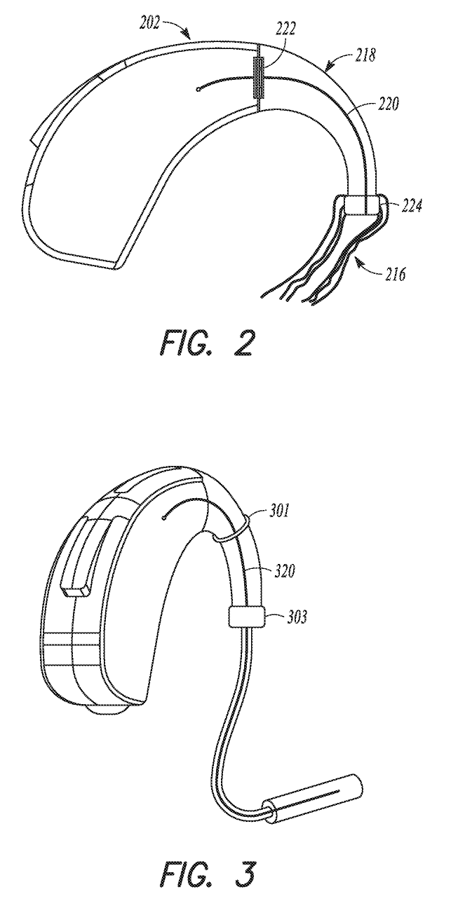

The RF coupler or direct electrical connection electrical conductors can be contained inside, attached to (inside or outside) or integrated partially or entirely into the heating aid spine, outer case, earhook, sound tube, earmold, earbud, or other structural parts. For example, the conductors can be partially or entirely embedded inside the coupling structures, and/or the conductors can be molded partially or entirely into the coupling structures. In FIG. 2 for example, a first coupler 222 is used to selectively link a portion of conductor 220 in the earhook 218 to the portion in the hearing aid housing 202, and a second coupler 224 is used to selectively link the portion of conductor 220 in the earhook 218 to a portion in sound tube 216.

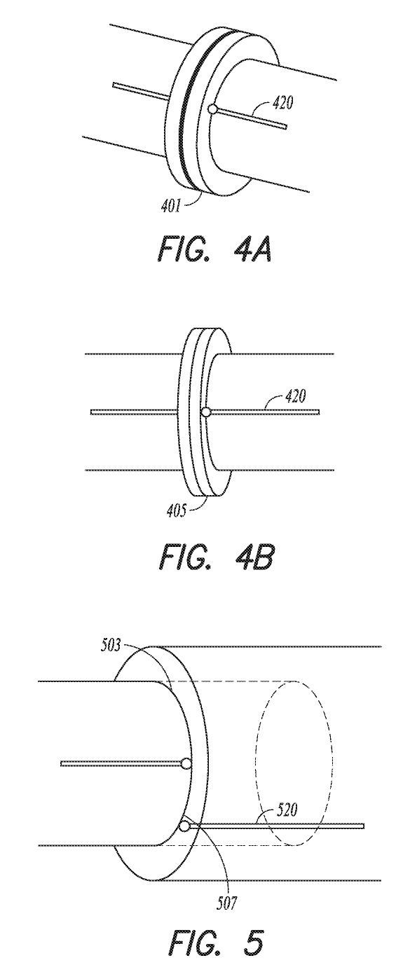

FIGS. 3-5 illustrate coupler embodiments, for example RF couplers for use with the present subject matter. A first coupler type is a washer style coupler 301 for use between earhook and case (or other mating surfaces that are removable) that uses two conductive surfaces (much like washers). The washer style coupler can either directly in contact (such as coupler 401) or with thin insulators between them (such as coupler 405) to create a washer-shaped parallel plate capacitor. The “washers” are directly connected to the electrical conductors 320, 420 on one side of the coupling region and couple via direct or alternating current (capacitive) coupling to the other side once assembled. In various embodiments, the washer style coupler does not interfere with sound tube/earhook acoustic behavior. Other RF coupler embodiments that provide contact or capacitive coupling can also be used. While the embodiments demonstrated in FIG. 4 are circular and planar in geometry, those of skill in the art upon reading and understanding the specification will appreciate that other geometries may be employed without departing from the scope of the present subject matter.

Another RF coupler embodiment is a sleeve like coupler. One example is a coupler for use between earhook and sound tube using metalized tubing and earhook exterior overlapping area that is conductive, such as sleeve style coupler 303 in FIG. 3. They can touch (direct contact sleeve coupler 503) or they can be insulated and will create a concentric-cylinder shaped capacitor 507. The “sleeve” area conductive cylinders are directly connected to the electrical conductors 320, 520 on one side of the coupling region and couple via direct or ac (capacitive) coupling to the other side once assembled. They surround but do not interfere with sound tube/earhook acoustic behavior. Other RF coupler embodiments that provide contact or capacitive coupling may also be used. Additional embodiments could be realized by substituting molded conductive polymer resin to form part or all of the earhook in the examples above.

In various embodiments, electrical conductors can include wire, other metal parts, and/or metalized polymers (coated or impregnated). The conductors can be attached to (inside or outside) or integrated into the earhook, sound tube and earmold/ear bud, in various embodiments. RF coupler or connector embodiments that provide contact or capacitive coupling may also be used. Earhook and sound tube antennas can be used to improve wireless charging efficiency of a hearing aid battery. In further embodiments, a pinna anchoring structure can be entirely or partially conductive and used with a sound tube and earmold/ear bud as an antenna element. The present subject matter provides for smaller, more discreet and more comfortable wireless hearing aids.

Hearing assistance devices typically include at least one enclosure or housing, a microphone, hearing assistance device electronics including processing electronics, and a speaker or “receiver.” Hearing assistance devices can include a power source, such as a battery. In various embodiments, the battery is rechargeable. In various embodiments multiple energy sources are employed. It is understood that in various embodiments the microphone is optional. It is understood that in various embodiments the receiver is optional. It is understood that variations in communications protocols, antenna configurations, and combinations of components can be employed without departing from the scope of the present subject matter. Antenna configurations can vary and can be included within an enclosure for the electronics or be external to an enclosure for the electronics. Thus, the examples set forth herein are intended to be demonstrative and not a limiting or exhaustive depiction of variations.

It is understood that digital hearing assistance devices include a processor. In digital hearing assistance devices with a processor, programmable gains can be employed to adjust the hearing assistance device output to a wearer's particular hearing impairment. The processor can be a digital signal processor (DSP), microprocessor, microcontroller, other digital logic, or combinations thereof. The processing can be done by a single processor, or can be distributed over different devices. The processing of signals referenced in this application can be performed using the processor or over different devices. Processing can be done in the digital domain, the analog domain, or combinations thereof. Processing can be done using subband processing techniques. Processing can be done using frequency domain or time domain approaches. Some processing can involve both frequency and time domain aspects. For brevity, in some examples drawings can omit certain blocks that perform frequency synthesis, frequency analysis, analog-to-digital conversion, digital-to-analog conversion, amplification, buffering, and certain types of filtering and processing. In various embodiments of the present subject matter the processor is adapted to perform instructions stored in one or more memories, which can or cannot be explicitly shown. Various types of memory can be used, including volatile and nonvolatile forms of memory. In various embodiments, the processor or other processing devices execute instructions to perform a number of signal processing tasks. Such embodiments can include analog components in communication with the processor to perform signal processing tasks, such as sound reception by a microphone, or playing of sound using a receiver (i.e., in applications where such transducers are used). In various embodiments of the present subject matter, different realizations of the block diagrams, circuits, and processes set forth herein can be created by one of skill in the art without departing from the scope of the present subject matter.

Various embodiments of the present subject matter support wireless communications with a hearing assistance device. In various embodiments the wireless communications can include standard or nonstandard communications. Some examples of standard wireless communications include, but not limited to, Bluetooth™, low energy Bluetooth, IEEE 802.11 (wireless LANs), 802.15 (WPANs), and 802.16 (WiMAX). Cellular communications can include, but not limited to, CDMA, GSM, ZigBee, and ultra-wideband (UWB) technologies. In various embodiments, the communications are radio frequency communications. In various embodiments the communications are optical communications, such as infrared communications. In various embodiments, the communications are inductive communications. In various embodiments, the communications are ultrasound communications. Although embodiments of the present system can be demonstrated as radio communication systems, it is possible that other forms of wireless communications can be used. It is understood that past and present standards can be used. It is also contemplated that future versions of these standards and new future standards can be employed without departing from the scope of the present subject matter.

The wireless communications support a connection from other devices. Such connections include, but are not limited to, one or more mono or stereo connections or digital connections having link protocols including, but not limited to 802.3 (Ethernet), 802.4, 802.5, USB, ATM, Fibre-channel, Firewire or 1394, InfiniBand, or a native streaming interface. In various embodiments, such connections include all past and present link protocols. It is also contemplated that future versions of these protocols and new protocols can be employed without departing from the scope of the present subject matter.

It is further understood that different hearing assistance devices can embody the present subject matter without departing from the scope of the present disclosure. The devices depicted in the figures are intended to demonstrate the subject matter, but not necessarily in a limited, exhaustive, or exclusive sense. It is also understood that the present subject matter can be used with a device designed for use in the right ear or the left ear or both ears of the wearer.

The present subject matter is demonstrated for hearing assistance devices, including hearing assistance devices, including but not limited to, behind-the-ear (BTE), in-the-ear (ITE), in-the-canal (ITC), receiver-in-canal (RIC), invisible-in-canal (IIC) or completely-in-the-canal (CIC) type hearing assistance devices. It is understood that behind-the-ear type hearing assistance devices can include devices that reside substantially behind the ear or over the ear. Such devices can include hearing assistance devices with receivers associated with the electronics portion of the behind-the-ear device, or hearing assistance devices of the type having receivers in the ear canal of the user, including but not limited to receiver-in-canal (RIC) or receiver-in-the-ear (RITE) designs. The present subject matter can also be used in hearing assistance devices generally, such as cochlear implant type hearing devices. The present subject matter can also be used in deep insertion devices having a transducer, such as a receiver or microphone. The present subject matter can be used in devices whether such devices are standard or custom fit and whether they provide an open or an occlusive design. It is understood that other hearing assistance devices not expressly stated herein can be used in conjunction with the present subject matter.

This application is intended to cover adaptations or variations of the present subject matter. It is to be understood that the above description is intended to be illustrative, and not restrictive. The scope of the present subject matter should be determined with reference to the appended claims, along with the full scope of legal equivalents to which such claims are entitled.

1. A hearing assistance device to provide sound to the ear of a user, the device comprising;
a housing configured to be worn on or behind the ear;
hearing assistance electronics enclosed in the housing;
an earmold configured to be worn in the ear;
a sound tube configured to connect to the earmold and to transmit an acoustic output to the earmold; and
an earhook configured to connect the housing to the sound tube, wherein the sound tube includes a conductive polymer forming at least a portion of an antenna for wireless communication.

2. The device of claim 1, wherein the conductive polymer includes a conductive polymer coating.

3. The device of claim 1, wherein the conductive polymer include a conductive polymer ink.

4. The device of claim 1, wherein the conductive polymer includes laser direct structured or other selectively plated polymers.

5. The device of claim 1, further comprising one or more couplers configured to be selected to include the one or more electrical conductors to form the antenna.

6. The device of claim 5, wherein the one or more couplers are selected to form a desired antenna element electrical length.

7. The device of claim 6, wherein the desired antenna element electrical length includes a one quarter wavelength at a desired frequency of operation.

8. The device of claim 1, wherein the housing includes a spine and wherein the spine includes a conductive polymer forming at least a portion of the antenna.

9. The device of claim 1, wherein the housing includes a microphone cover and wherein the microphone cover includes a conductive polymer forming at least a portion of the antenna.

10. The device of claim 1, wherein the housing includes a battery door and wherein the battery door includes a conductive polymer forming least a portion of the antenna.

11. The device of claim 1, wherein the earhook includes an earhook attachment structure and wherein the earhook attachment structure includes a conductive polymer forming at least a portion of the antenna.

12. The device of claim 1, wherein the hearing assistance device is a hearing aid.

13. The device of claim 3, wherein the hearing aid is a behind-the-ear (BTE) hearing aid.

14. A hearing assistance device to provide sound to the ear of a user, the device comprising;
a housing configured to be worn on or behind the ear;
hearing assistance electronics enclosed in the housing;
a wireless communications receiver in the housing and configured to connect to the hearing assistance electronics;
an earmold configured to be won in the ear;
a sound tube configured to connect to the earmold and to transmit an acoustic output to the earmold;
an earhook configured to connect the housing to the sound tube, wherein the sound tube includes an electrical conductor configured to provide at least a portion of an antenna for wireless communication; and
one or more couplers configured to selectively couple the electrical conductor to the wireless communications receiver to form the antenna.

15. The device of claim 14, wherein the one or more couplers include a radio frequency coupler.

16. The device of claim 14, wherein the one or more couplers include a direct electrical connection.

17. The device of claim 14, wherein the one or more couplers include wire or formed metal components.

18. The device of claim 14, wherein the one or more couplers include conductors on rigid or flex circuit boards.

19. The device of claim 4, wherein the one or more couplers include a conductive polymer.

20. The device of claim 14, wherein the one or more couplers are contained inside, attached to or integrated partially or entirely into the housing, earhook, sound tube, earmold, or other structural part of the hearing assistance device.
